(19) United States
(12) Patent Application Publication
(10) Pub. No.: US 2007/0069852 A1
(43) Pub. Date: Mar. 29, 2007

(54) Method for securing information between RFID reader and tag, and RFID reader and tag using the same

(76) Inventors: Hee-Sook Mo, Daejon (KR); Ji-Hoon Bae, Daejon (KR); Dong-Han Lee, Daejon (KR); Chenghao Quan, Jilin Province (CN); Gil-Young Choi, Daejon (KR); Cheol-Sig Pyo, Daejon (KR); Jong-Suk Chae, Daejon (KR)

Correspondence Address: LADAS & PARRY LLP, 224 SOUTH MICHIGAN AVENUE, SUITE 1600, CHICAGO, IL, 60604, US

(21) Appl. No.: 11/525,393

(22) Filed: Sep. 22, 2006

(30) Foreign Application Priority Data
Sep. 23, 2005 (KR) 10-2005-0088929
Jun. 12, 2006 (KR) 10-2006-0052611

(51) Int. Cl. G05B 19/00

(52) U.S. Cl. 340/5.1

(57) ABSTRACT

Provided is a method for securing information between a Radio Frequency Identification (RFID) reader and tag, and an RFID Reader and tag using the same. The method includes the steps of: a) requesting an access password of the RFID tag in the RFID reader; b) extracting a key value mapped to the access password transmitted from the RFID tag and transmitting the key value to the RFID tag in the RFID reader; c) outputting a hash function value from the key value transmitted from the RFID reader in the RFID tag; and d) determining whether to allow the RFID reader to access to an RFID tag memory based on whether the outputted hash function value is the same as the access password of the RFID tag.

### FIELD OF THE INVENTION

The present invention relates to a method for securing information between a Radio Frequency Identification (RFID) reader and tag, and an RFID Reader and tag using the same; and, more particularly, to a method for securing information between an RFID reader and tag to prevent transmitting/receiving information between the RFID reader and the tag from being overflown to a non-authenticated user in an RFID wireless interface environment, and an RFID Reader and tag using the same.

### DESCRIPTION OF RELATED ART

In general, Radio Frequency Identification (RFID) is a technology for recognizing, tracking and managing a material, an animal or human being with an RFID tag by contactlessly reading or recording information from the RFID tag having identification information by using wireless frequency. An RFID system includes a plurality of RFID tags, e.g., an electronic tag or a transponder, which have identification information and are attached to a material or an animal, and an RFID reader for reading or writing information of the RFID tag.

The RFID system is divided into a mutual inducing method and an electromagnetic wave method according to a mutual communication method between the RFID reader and the tag. The RFID system is also divided into an active type and a passive type based on whether the RFID tag is operated with its own power source. Also, RFID systems are divided into a long wave type, a medium wave type, a short wave type, a high frequency type, and an ultra high frequency (UHF) type based on a used frequency.

A ubiquitous sensor network (USN) means attaching the RFID tag to a certain place, detecting environment information as well as recognition information of a material with the RFID tag, connecting the information to a network in real-time and managing the information. Ultimately, an object of the ubiquitous sensor network is to realize an environment capable of communicating regardless of kinds of a network, a device, and a service anytime and anywhere by allocating computing and communicating functions to all materials.

An ultra high frequency (UHF) band ranging from 860 MHz to 960 MHz is expected to be widely applied as a frequency band of an RFID/USN wireless equipment. In case of a protocol of parameters for air interface communications at 860 MHz to 960 MHz (ISO/IDC 18000-6 Type C) adopted as an RFID international standard of a current UHF band, transmitting/receiving data between the RFID reader and tag can be wiretapped or monitored. It shows serious security problem. That is, since all data packets transmitted/received between the RFID reader and tag in a UHF wireless section are exposed to readers within an electromagnetic wave coverage region, information on the packets is in a vulnerable security status and can be wiretapped by an ill-intentioned third party. In the vulnerable security status, there is a high possibility that private information or other important information stored in a RFID tag memory may be stolen or counterfeited. Also, when a non-authenticated third party accesses to the RFID tag memory and deletes some data items or writes certain information, the RFID reader and the RFID tag may exchange wrong data. Accordingly, communications between the RFID reader and tag can be exposed to lethal risk.

### SUMMARY OF THE INVENTION

It is, therefore, an object of the present invention to provide a method for securing information between a Radio Frequency Identification (RFID) reader and tag to prevent transmitting/receiving information between the RFID reader and tag from being overflown to a non-authenticated user in an RFID wireless interface environment, and an RFID Reader and tag using the same. To be specific, the object of the present invention is to provide a method for encoding data transmitted/received between the RFID reader and the tag in conformity to an international standard between the RFID reader and tag, and an RFID reader and tag using the same.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

In accordance with an aspect of the present invention, there is provided a method for securing information between an RFID reader and an RFID tag, the method including the steps of: a) requesting an access password of the RFID tag in the RFID reader; b) extracting a key value mapped to the access password transmitted from the RFID tag and transmitting the key value to the RFID tag in the RFID reader; c) outputting a hash function value from the key value transmitted from the RFID reader in the RFID tag; and d) determining whether to allow the RFID reader to access to an RFID tag memory based on whether the outputted hash function value is the same as the access password of the RFID tag. When the outputted hash function value is the same as the access password of the RFID tag, the status of the RFID tag is converted into a secured status. The lock of the RFID tag can be lifted by converting a lock flag according to a reader command.

In accordance with another aspect of the present invention, there is provided a method for protecting information of the RFID tag, the method including the steps of: a) creating a random key value; b) calculating a hash function value from the random key value and transmitting the hash function value to the RFID tag; c) storing the random key value and the hash function value in the RFID reader; and d) storing the hash function value transmitted from the RFID reader as an access password of the RFID tag and converting a status of the RFID tag into a lock status.

In accordance with another aspect of the present invention, there is provided an RFID reader, including: a control unit for creating a message for requesting an access password of an RFID tag; and a memory for storing the access password and a key value corresponding to the access password, wherein the RFID reader extracts the key value corresponding to the access password transmitted from the RFID tag in the memory and transmitting the extracted key value to the RFID tag. The access password is a hash function value of the corresponding key value. The RFID reader further includes: a random key creating unit for creating a random key value; and a hash function calculating unit for calculating the hash function value from the random key value, wherein the RFID reader creates a message for recording the hash function value as a new access password of the RFID tag and transmitting the message to the RFID tag. The RFID reader memory stores the random key and the hash function value calculated from the random key in a table.

In accordance with another aspect of the present invention, there is provided an RFID tag, including: a memory for storing an access password of the RFID tag; and a signal processing unit for outputting a hash function value from a key value transmitted from the RFID reader and allowing memory access when the outputted hash function value is the same as the stored access password. When the outputted hash function value is the same as the stored access password, a status of the RFID tag is converted into a secured status and the lock status is lifted. Also, when the hash function value outputted from the random key value is transmitted from the RFID reader, the hash function value is stored as a new access password and the status of the RFID tag is converted into the lock status.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a Radio Frequency Identification (RFID) system to which the present invention is applied;

FIG. 2 shows a memory structure of the RFID tag. The memory of the RFID tag is divided into the user memory, the TID memory, the UII memory, and the reserved memory;

FIG. 3 shows a memory of the RFID reader and the RFID tag in accordance with an embodiment of the present invention;

FIG. 4 is a flowchart describing an RFID tag memory lock process in accordance with the embodiment of the present invention;

FIG. 5 is a flowchart describing a process for lifting lock of the RFID tag memory in accordance with the embodiment of the present invention;

FIG. 6 is a flowchart describing a conventional process for accessing to the RFID tag in conformity to an ISO/IEC 18000-6C standard; and

FIG. 7 is a flowchart describing a process for accessing to the RFID tag in conformity to an ISO/IEC 18000-6C standard, to which the present invention is applied.

### DETAILED DESCRIPTION OF THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

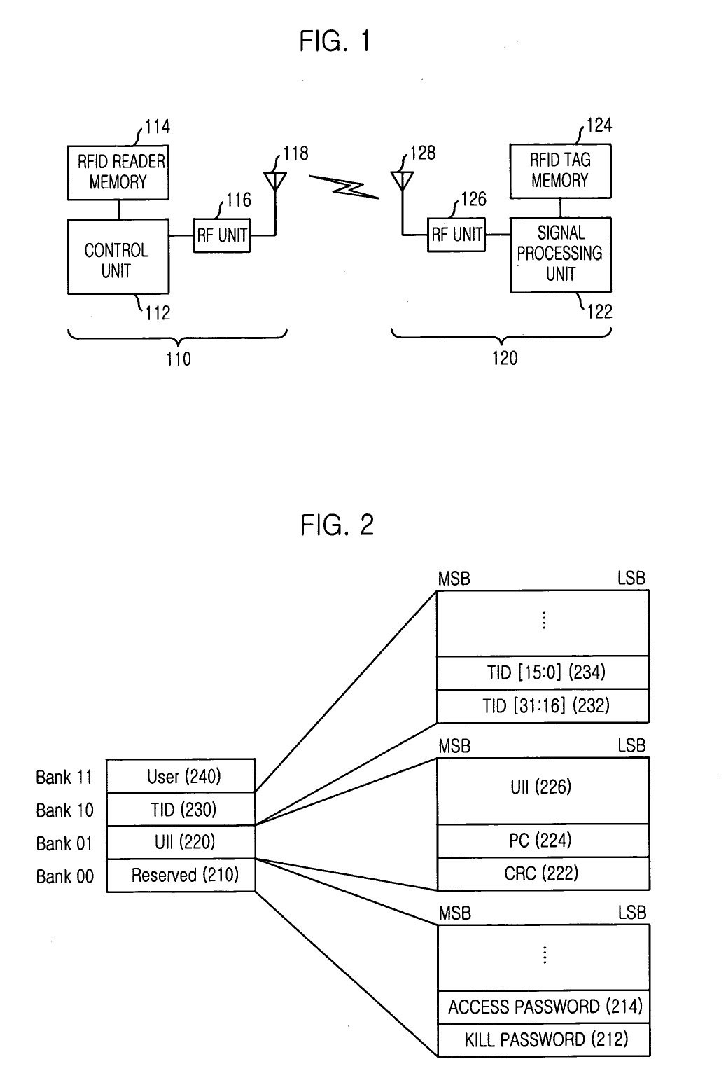

FIG. 1 is a block diagram showing a Radio Frequency Identification (RFID) system to which the present invention is applied. The RFID system includes a tag, e.g., an electronic tag and a transponder, which is attached to a certain place and stores item information, and an RFID reader for reading and writing information of the tag.

An RFID reader 110 includes a control unit 112, an RFID reader memory 114 and an RF unit 116.

The control unit 112 controls a general operation of the RFID reader. The RFID reader memory 114 stores a command and programs required for the RFID reader operation. The RF unit 116 transmits/receives an RF signal to/from the RFID tag.

The control unit 112 recovers the RFID tag signal transmitted from an RF unit in an ultra high frequency (UHF) band in conformity to an RFID standard, and creates and encodes a message to be transmitted to the RFID tag. Also, the control unit 112 operates an RFID tag memory lock process and a lock release process in accordance with an embodiment of the present invention. That is, the control unit 112 creates a random key value, calculates an access password to be stored in the RFID tag and extracts a key value for the access password transmitted from the RFID tag.

The RFID reader memory 114 includes a program memory and data memories. The program memory stores programs for controlling a general operation of the RFID reader and a hash function. Also, the data memory stores data generated during communicating with the RFID tag and a mapping table of the access password and the key value

The RFID tag 120 includes a signal processing unit 122 for processing a signal of the RFID tag, an RFID tag memory 124 for storing a command and programs required for the RFID tag operation, and an RF unit 126 for transmitting/receiving an RF signal to/from the RFID reader.

The signal processing unit 122 recovers the RFID reader signal transmitted from the RF unit in conformity to the RFID standard in the UHF band, and creates a message for back scatter modulation to the RFID reader. Also, the signal processing unit 122 operates the RFID tag memory lock process and the lock release process in accordance with the embodiment of the present invention.

The signal processing unit 122 receives the access password created by a random key value in the RFID reader, stores the access password in the RFID tag memory and determines whether to release the lock by comparing a hash function output value having the key value transmitted from the RFID reader as an input value, with the stored access password.

The RFID tag memory 124 includes a program memory and data memories. The program memory stores programs for controlling a general operation of the RFID tag and a hash function. Also, the data memory includes memory regions such as a user memory, a tag identification (TID) memory, a unique item identifier (UII) memory and a reserved memory in the UHF band, in conformity to the RFID standard.

FIG. 2 shows a memory structure of the RFID tag. The memory of the RFID tag is divided into the user memory, the TID memory, the UII memory, and the reserved memory.

A user memory 240 stores value-added important information for the RFID service, and is used according to kinds of the services to be provided. A TID memory 230 stores physical serial IDs 232 and 234 of the RFID tag. A UII memory 220 stores a UII 226 for defining an item with the RFID tag. The UII 226 is used to access to the information stored in the RFID tag of the RFID service. Object information of the item corresponding to the UII is stored in the user memory 240. A reserved memory 210 stores an access password 214 required for controlling a lock flag of the RFID tag.

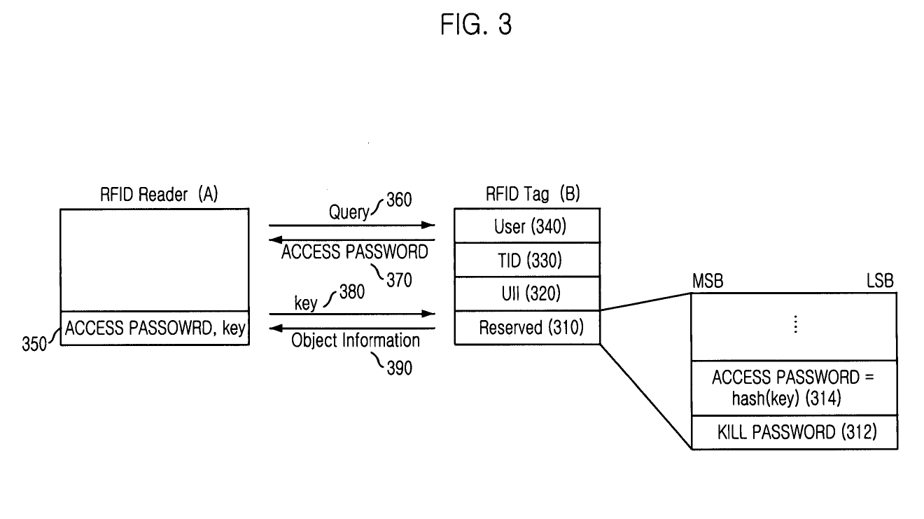

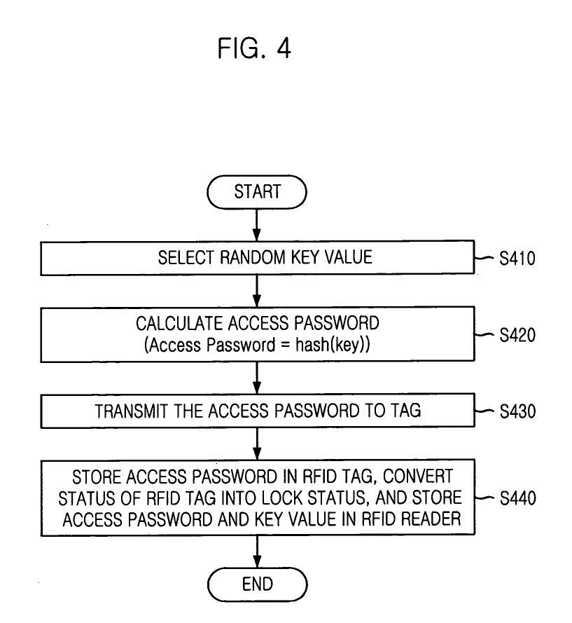

FIG. 3 shows a memory of the RFID reader and the RFID tag and FIG. 4 is a flowchart describing an RFID tag memory lock process in accordance with the embodiment of the present invention.

The present invention protects important object information stored in the RFID tag by applying an encoding technique based on the hash function by reflecting RFID tag restrictions of a low price and a light weight.

Referring to FIG. 4, the RFID reader selects a random key value at step S410, calculates a hash function output value having the selected key value as an input value at step S420 and transmits the hash function output value to the RFID tag at step S430. The RFID tag stores the hash function output value as an access password in a reserved memory 310 and the status of the RFID tag is converted into a lock status at step S440. That is, the RFID tag stores the hash function output value calculated in the RFID reader in the access password memory of the reserved memory, and the status of the RFID tag is converted into the lock status. In the lock status, it is not possible to access to a specific memory of the RFID tag or record data. Also, the RFID tag responds to a query of the RFID reader with the access password value stored in the reserved memory 310 and other functions are restricted. Therefore, the authenticated RFID reader should release the lock status of the RFID tag to access to the RFID tag memory in the lock status and acquire or record information. The RFID reader transmitting the access password to the RFID tag stores the access password and a mapping table including key value information corresponding to the access password in the RFID reader memory.

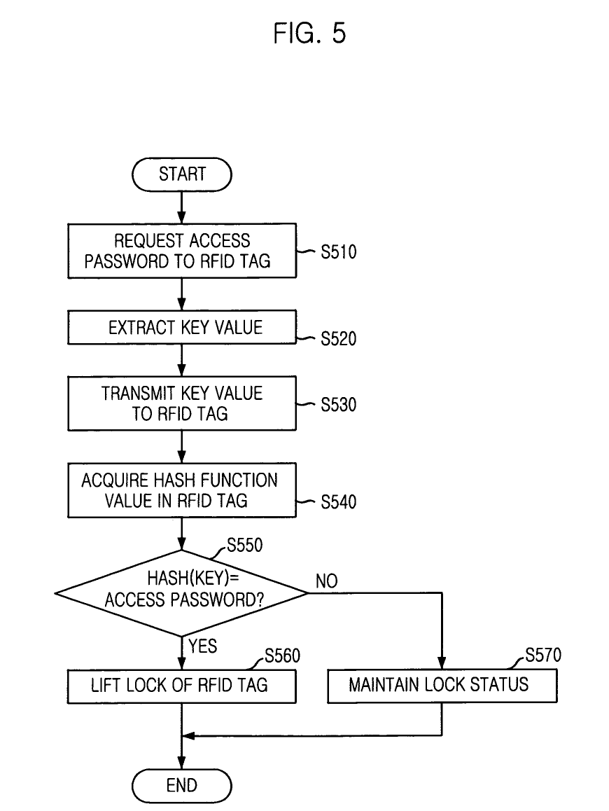

FIG. 5 is a flowchart describing a process for lifting lock of the RFID tag memory in accordance with the embodiment of the present invention.

Referring to FIGS. 3 and 5, the RFID reader for lifting the lock of the RFID tag memory requests the access password to the RFID tag at step S510. Subsequently, the RFID reader receives an access password 370 from the RFID tag and extracts a key value corresponding to the transmitted access password from the mapping table stored in the RFID reader memory at step S520. The RFID reader transmits an extracted key value 380 to the RFID tag at step S530. The RFID tag compares a value acquired by performing a hash function on the key value transmitted from the RFID reader at step S540 with the access password pre-stored in a reserved memory 310 at step S550.

When the compared values are not the same, the RFID tag maintains the lock status at step S570.

When the compared values are the same, the RFID tag lifts the lock of the RFID tag at step S560. The RFID reader can acquire or record desired information by accessing to the memory of the RFID tag where the lock is lifted.

When the RFID reader ends communicating with the RFID tag, the RFID reader creates a new key value again, calculates a new access password and transmits the new access password to the RFID tag. That is, the RFID reader prevents outflow of the RFID tag information by ending the communication with the RFID tag and performing the RFID tag memory lock process of steps S410 to S440. When the non-authenticated third party does not know access password for accessing to the RFID tag memory and the Key value, the non-authenticated third party cannot access to the RFID tag memory and the RFID tag information is effectively protected.

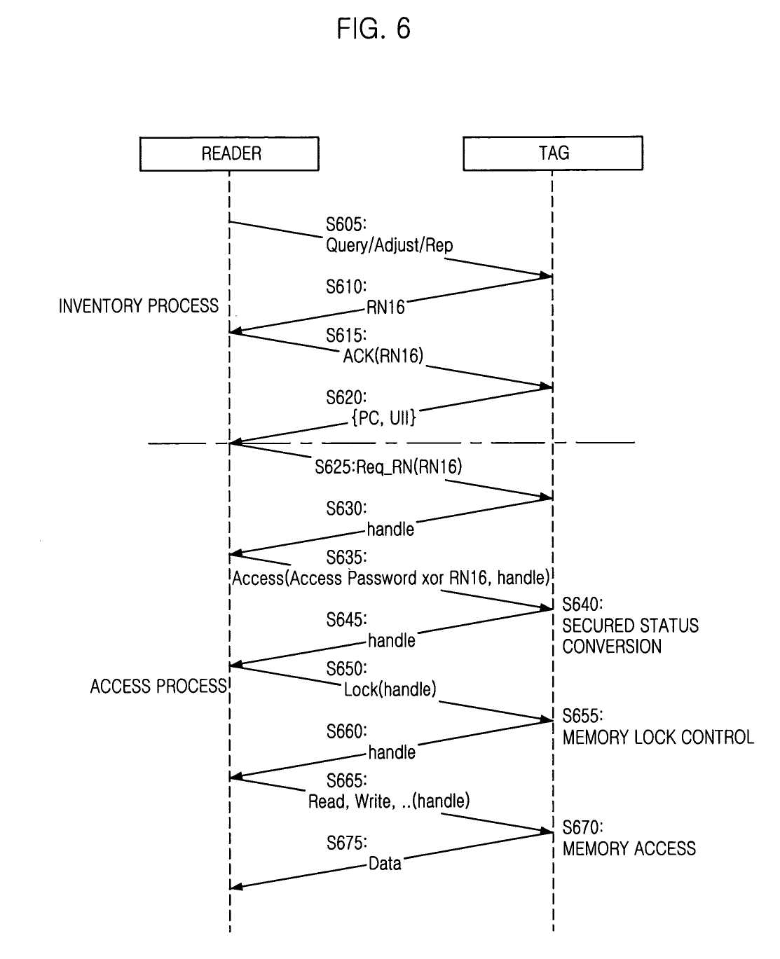

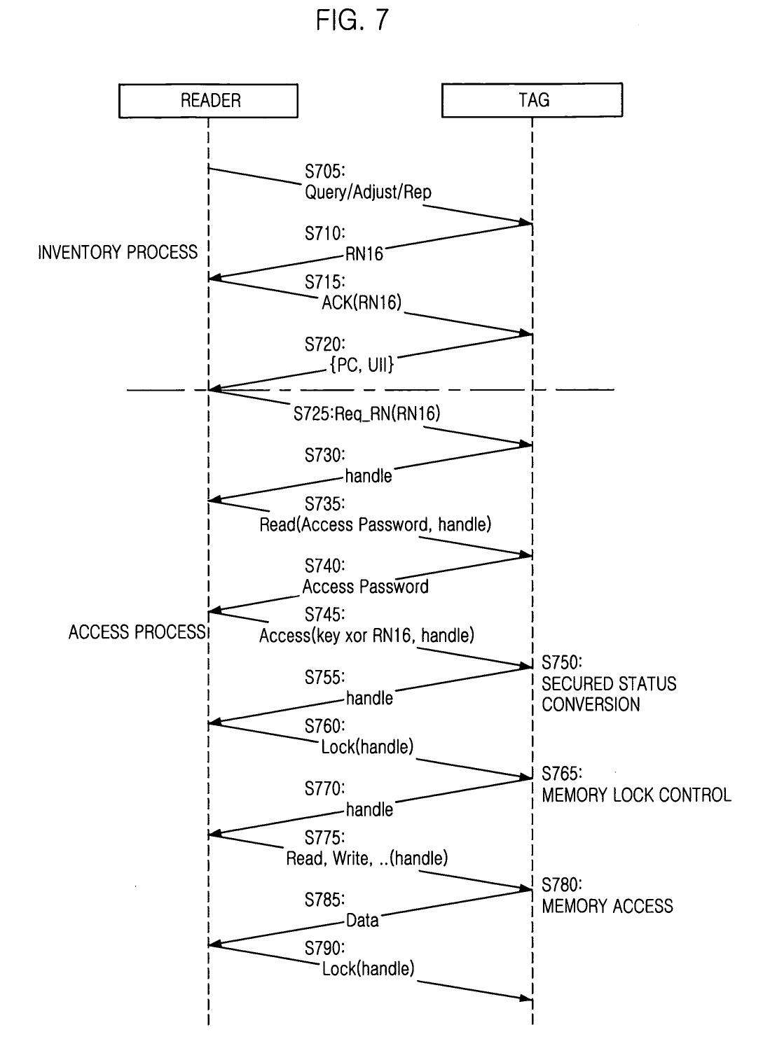

FIGS. 6 and 7 are flowcharts describing a process for accessing to the RFID tag in conformity to an ISO/IEC 18000-6C standard. FIG. 6 shows a conventional RFID tag access process and FIG. 7 shows the RFID tag access process, to which the present invention is applied.

Referring to FIG. 6, the RFID reader performs inventory processes of steps S605 to S620, and access processes of steps S630 to S675 to acquire information from a specific RFID tag.

In the inventory processes of the steps S605 to S620, UII of the selected RFID tag is acquired by selecting a specific RFID tag among a plurality of the RFID tags within the RF coverage. The RFID reader queries to the RFID tag by using commands such as Query, QueryAdjust and QueryRep. When a slot of the RFID tag receiving a query is 0, the RFID tag responds to the query of the RFID reader by performing back scatter modulation on a random number 16 (RN16) to the RFID reader at steps S605 and S610. At step S615, the RFID reader transmits an ACK command including the RN16 information transmitted from the RFID tag to respond that the RN16 is transmitted. When the RN16 information transmitted from the RFID reader is effective, the RFID tag performs back scatter modulation on the UII and protocol-control bits (PC) at step S620.

Steps S630 to S675 shows a process for accessing to a memory bank of the RFID tag to acquire and store important information stored in the memory of the RFID tag selected in the inventory process. The RFID reader acquiring the UII of the RFID tag creates a new RN16 through a Req_RN command and indicates the RFID tag to perform back scatter modulation at step S625. When the RN16 included in the Req_RN command is effective information, the RFID tag creates and transmits a new RN16, which is called a handle hereinafter, to the RFID reader at step S630. The RFID reader transmits an Access command including a result value obtained by performing an exclusive logical sum (XOR) onto the access password and the RN16, and the handle transmitted from the RFID tag to the RFID tag.

The RFID tag receiving the access command is in the status that the lock function for limiting a specific memory bank from being read and written is set up or lifted to secure important data.

When the handle and the access password are effective information, the status of the RFID tag receiving the access command from the RFID reader is converted into a secured status where the lock status can be controlled by the RFID reader. The RFID reader lifts the lock of the RFID tag, and can acquire or record desired information from the RFID tag memory.

The conventional RFID tag access process described above has a serious problem that a message packet transmitted/received between the RFID reader and the RFID tag can be exposed to a non-authenticated third party in a wireless environment. That is, there is a possibility that a non-authenticated RFID reader captures packet information within the RFID reader coverage, accesses to the memory of the RFID tag, counterfeits private information and changes the access password.

FIG. 7 is a flowchart describing a process for accessing to the RFID tag in conformity to an ISO/IEC 18000-6C standard, to which the present invention is applied. The RFID tag access process of the present invention includes inventory process of steps S705 to S725 and an access process of steps S730 to S790. Since the inventory process is the same as described in FIG. 6, an access process of the RFID reader in the steps S730 to S790 of the present invention will be described hereinafter.

The RFID reader acquiring the UII of the RFID tag through the inventory process creates a new RN16 through a Req_RN command and indicates the RFID tag to perform back scatter modulation at step S725. When the RN16 included in the Req_RN command is effective information, the RFID tag creates and transmits a new RN16, i.e., the handle, to the RFID reader at step S730. Subsequently, the RFID reader transmits a “Read” command for reading the access password of the RFID tag to the RFID tag at step S735. When the handle included in the “Read” command is effective information, the RFID tag performs back scatter modulation on the access password at step S740. The RFID reader extracts a key value mapped with the access password, which is transmitted from the RFID tag, from the table stored in the RFID reader memory, and transmits a result value of the exclusive logical sum (XOR) operation between the extracted key value and the RN16, and the handle to the RFID tag through the access command at step S745. The RFID tag receiving the access command applies a hash function to the key value extracted from the RFID reader and is converted into the secured status at step S750 only when the result is the same as the access password pre-stored in the reserved memory of the RFID tag memory. Since accessing to the RFID tag memory and the lock flag can be allowed to only the RFID reader, the RFID tag information can be stably protected. The RFID tag converted into the secured status transmits the handle to the RFID reader at step S770. The RFID reader performs reading and writing functions with the handle as parameter at step S775. Also, the RFID reader can change the lock flag of the RFID tag through a lock command with the handle as a parameter. The RFID reader intending to communicate with the RFID tag creates an access password based on a new key value and stores the access password in the RFID tag. That is, when the RFID reader ends the communication with the RFID tag, the RFID tag memory lock process of the steps S410 to S440 is repeated. When the RFID reader of the non-authenticated user with bad intention does not know the access password encoded by the hash function and the Key value, the RFID reader cannot access to the RFID tag memory.

As described above, the present invention can provide a method for securing information between the RFID reader and tag to prevent transmitting/receiving information between the RFID reader and the tag from being outflown of to a non-authenticated user in the RFID wireless interface environment, and an RFID Reader and tag using the same.

In particular, the present invention encodes and stores the access password of the RFID tag by the hash function to prevent the access of the non-authenticated RFID reader to the RFID tag memory. Accordingly, the present invention can prevent counterfeit and modulation of the important information stored in the RFID tag.

Also, since the present invention provides a method for effectively protecting information on the RFID tag, the user can safely read or record diverse object information in the RFID tag memory. Therefore, the present invention can provide diverse kinds of information stored in the RFID tag and diverse RFID application services.

As described in detail, the technology of the present invention can be realized as a program and stored in a computer-readable recording medium, such as CD-ROM, RAM, ROM, a floppy disk, a hard disk and a magneto-optical disk. Since the process can be easily implemented by those skilled in the art of the present invention, further description will not be provided herein.

The present application contains subject matter related to Korean patent applications No. 2005-0088929 and No. 2006-0052611, filed with the Korean Intellectual Property Office on Sep. 23, 2005, and Jun. 12, 2006, respectively. The entire contents are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A method for securing information between a Radio Frequency Identification (RFID) reader and an RFID tag, comprising the steps of:
a) requesting an access password of the RFID tag in the RFID reader;
b) extracting a key value mapped to the access password transmitted from the RFID tag and transmitting the key value to the RFID tag in the RFID reader;
c) outputting a hash function value from the key value transmitted from the RFID reader in the RFID tag; and
d) determining whether to allow the RFID reader to access to an RFID tag memory based on whether the outputted hash function value is the same as the access password of the RFID tag.

2. The method as recited in claim 1, further comprising the step of:
e) converting the status of the RFID tag into a secured status when the outputted hash function value is the same as the access password of the RFID tag.

3. The method as recited in claim 1, further comprising the step of:
f) lifting lock of the RFID tag when the outputted hash function value is the same as the access password of the RFID tag.

4. The method as recited in claim 1, further comprising the steps of:
g) creating a random key value in the RFID reader;
h) calculating a hash function value from the random key value in the RFID reader and transmitting the hash function value to the RFID tag;
i) storing the random key value and the hash function value in the RFID reader memory; and
j) storing the hash function value transmitted from the RFID reader as a new access password in the RFID tag memory.

5. A method for protecting information of a Radio Frequency Identification (RFID) tag, comprising the steps of:
a) creating a random key value;
b) calculating a hash function value from the random key value and transmitting the hash function value to the RFID tag;
c) storing the random key value and the hash function value in the RFID reader; and
d) storing the hash function value transmitted from the RFID reader as an access password of the RFID tag and converting a status of the RFID tag into a lock status.

6. The method as recited in claim 5, further comprising the steps of:
e) requesting the access password of the RFID tag in the RFID reader;
f) extracting a key value mapped to the access password and transmitting the key value to the RFID tag;
g) outputting a hash function value from the key value; and
h) lifting the lock of the RFID tag when the hash function value outputted in the RFID tag is the same as the access password of the RFID tag.

7. The method as recited in claim 6, wherein the step h) includes the steps of:
h1) converting the status of the RFID tag into a secured status when the hash function value is the same as the access password of the RFID tag; and
h2) lifting the lock by converting a lock flag according to a command of the RFID reader when the RFID tag converted into the secured status is in the lock status.

8. A Radio Frequency Identification (RFID) reader, comprising:
a control means for creating a message for requesting an access password of an RFID tag; and
a memory for storing the access password and a key value corresponding to the access password,
wherein the RFID reader extracts the key value corresponding to the access password transmitted from the RFID tag in the memory and transmitting the extracted key value to the RFID tag.

9. The RFID reader as recited in claim 8, wherein the access password is a hash function value of the corresponding key value.

10. The RFID reader as recited in claim 8, further comprising:
a random key creating means for creating a random key value; and
a hash function calculating means for calculating the hash function value from the random key value,
wherein the RFID reader creates a message for recording the hash function value as a new access password of the RFID tag and transmitting the message to the RFID tag.

11. The RFID reader as recited in claim 10, wherein the memory stores the random key and the hash function value calculated from the random key in a table.

12. A Radio Frequency Identification (RFID) tag, comprising:
a memory for storing an access password of the RFID tag; and
a signal processing means for outputting a hash function value from a key value transmitted from the RFID reader and allowing memory access when the outputted hash function value is the same as the stored access password.

13. The RFID tag as recited in claim 12, wherein a status of the RFID tag is converted into a secured status when the outputted hash function value is the same as the stored access password.

14. The RFID tag as recited in claim 12, wherein the lock status is lifted when the outputted hash function value is the same as the stored access password.

15. The RFID tag as recited in claim 12, wherein when the hash function value outputted from the random key value is transmitted from the RFID reader, the hash function value is stored as a new access password and the status of the RFID tag is converted into the lock status.
